(19) United States
(12) Patent Application Publication
(10) Pub. No.: US 2009/0125215 A1
(43) Pub. Date: May 14, 2009

(54) VARIABLE VALVE TIMING CONTROL SYSTEM AND METHOD

(75) Inventor: Johan BLOM, Goteborg (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/937,085

(22) Filed: Nov. 8, 2007

(51) Int. Cl. F02D 41/00

(52) U.S. Cl. 701/105

(57) ABSTRACT

An engine control system is provided for an internal combustion system having variable valve timing operated by at least one variable valve actuator. The engine control system is operable to calculate fuel injection amounts based on predicted volumetric efficiency and to delay a control signal for initiation of the variable valve actuator by a control delay timing. An embodiment can provide compensation for fuel amounts injected despite rapid variable valve actuation.

### BACKGROUND

1. Field of the Invention

This invention relates to a variable valve timing system and method for an internal combustion engine.

2. Related Art

In a modern engine, an amount of fuel to be injected into a cylinder in a given cycle for a given lambda value is related to the air mass for the cycle at an intake manifold for the cylinder. In order to calculate the required injection amount, an estimation of the amount of air inducted into the engine is computed.

In a steady operating condition of the engine, the computation of the air mass will typically be the same for successive cycles. However, in a transient situation, for example where a throttle setting changes, the amount of air inducted to a combustion chamber (for example a cylinder) of the engine can change after a fuel injection amount is calculated for the combustion. This is because closing of an intake valve for the combustion chamber can occur later than the injection. This is particularly the case for a port fuel injection engine where injection into an intake port common to multiple combustion chambers can occur significantly earlier than the intake valve closing timing. However, it also applies to a direct fuel injection where fuel is injected directly into a combustion chamber.

An example of the relative timings in the case of a transient situation in a port injection engine is illustrated in FIG. 1. At 11, a fuel injection amount is computed based on the air mass estimation. At 11, the computation of the fuel injection amount is completed and at 13 fuel injection 12 terminates at a timing to provide the computed fuel injection amount. The intake stroke 14 terminates at 15 when the intake valve closes. If, during this period, the throttle setting changes then the airflow at the injection timing will be different from that at the valve closing time as represented by the line 16 in FIG. 1. As a result, the fuel to air mixture will be different from the amount used as the basis for the fuel injection amount as represented by the arrow 17. In order ensure efficient combustion, fuel compensation for the changed airflow is needed.

FIG. 2 is a schematic block diagram illustrating conventional airflow computation using a dynamic intake model 18 based on various engine operating parameters 19 including, for example, throttle angle, variable valve timing, engine speed, ambient pressure intake temperature, etc. In order to take predict the charge of air in transient conditions, computation is based on a predicted throttle angle with current values of other parameters being held constant.

The present invention seeks to provide for improved fuel injection compensation in transient operating conditions of an internal combustion engine with a variable valve timing system

### SUMMARY

An embodiment of the invention provides an engine control system for an internal combustion system having variable valve timing operated by at least one variable valve actuator. The engine control system can be operable to calculate fuel injection amounts based on predicted volumetric efficiency and to delay a control signal for initiation of the variable valve actuator by a control delay timing.

An embodiment of the invention also provides an internal combustion engine having variable valve timing operated by at least one variable valve actuator that includes such an engine control system.

An embodiment of the invention can also provide a method of controlling variable valve timing of an internal combustion system, the variable valve timing being operated by at least one variable valve actuator. The method comprises calculating fuel injection amounts based on predicted volumetric efficiency, and delaying a control signal for initiation of the variable valve actuator by a control delay timing.

An embodiment of the invention can provide compensation for fuel amounts injected in transient variable valve actuation situations.

Although various aspects of the invention are set out in the accompanying independent claims, other aspects of the invention include any combination of features from the described embodiments and/or the accompanying dependent claims with the features of the independent claims, and not solely the combinations explicitly set out in the accompanying claims.

### BRIEF DESCRIPTION OF THE FIGURES

Specific embodiments of the present invention will now be described by way of example only with reference to the accompanying drawings.

FIG. 1 represents is a timing diagram representing relative timings in a port injection engine;

FIG. 2 is a schematic block diagram of a prior art dynamic intake model;

FIG. 3 is a schematic block diagram of an engine system;

FIG. 4 is a schematic representation of a variable valve timing system of the engine system of FIG. 3;

FIG. 5 is timing diagram illustrating the effect of variable valve timing;

FIG. 6 is a schematic diagram of functional modules of an example engine control module for the engine system of FIG. 3;

FIGS. 7A-7D are timing diagrams illustrating the operation of an example embodiment of the invention; and

FIG. 8 is a schematic representation of an example of a motor vehicle comprising the engine system of FIG. 3.

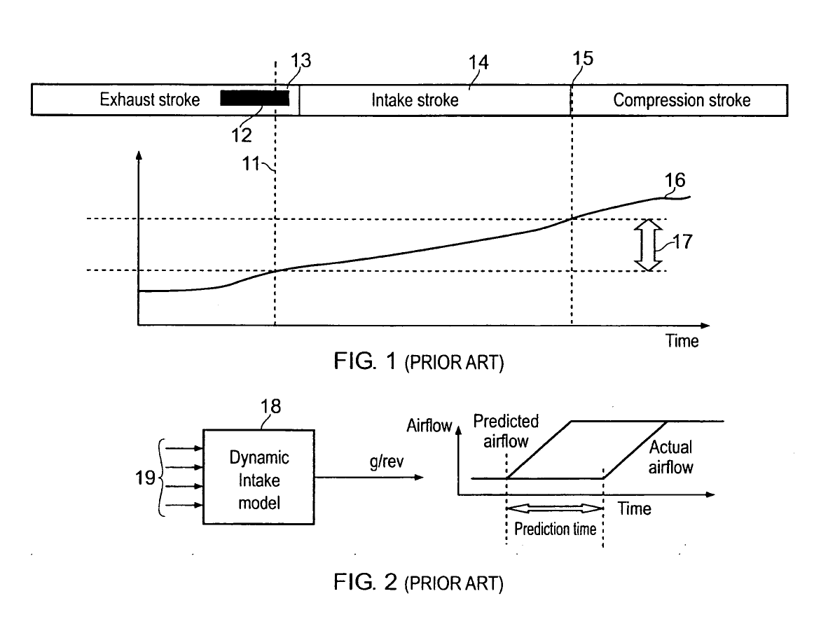

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

Embodiments of the invention will now be described with reference to the accompanying drawings in which an engine control system and method for an internal combustion system that has variable valve timing operated by at least one variable valve actuator calculates fuel injection amounts based on predicted volumetric efficiency and delays a control signal for initiation of the variable valve actuator by a control delay timing.

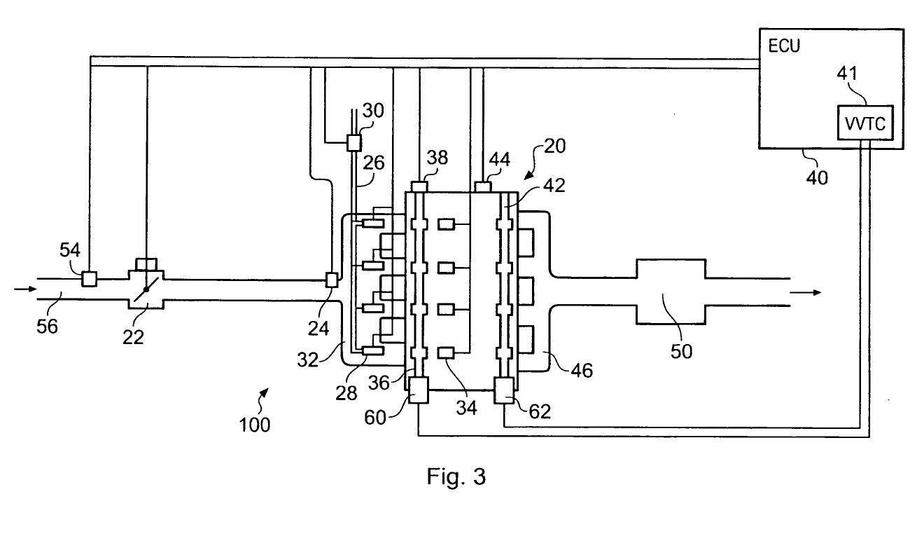

An example embodiment of the invention is described with reference to an example engine system 100 illustrated in block diagrammatic form in FIG. 3. The internal combustion engine 20 represented in FIG. 3 is a four cylinder gasoline engine. The engine system is controlled by an engine control unit (ECU) 40 which is connected to various sensors and control subsystems of the engine system 100. The ECU controls the operation of a throttle 22 at the intake side of the engine. In the example shown, a port fuel injector 28 for each cylinder is provided in the inlet manifold 32 and is connected to a fuel supply line 26. A pressure regulator 30 is used to control fuel pressure in the fuel supply line 26 and the individual injectors 28 receive control signals from the ECU to control the timed injection of fuel. Spark plugs 34 receive ignition timing (IGT) signals from the ECU 40.

The engine control unit 40 receives signals from camshaft sensor 38 and a crankshaft sensor 44 indicating the timing of the rotation of intake camshaft 36 and the engine crankshaft (not shown), respectively. In addition, an exhaust camshaft sensor may be provided for the exhaust camshaft 42. The intake and exhaust camshafts 36 and 42 respectively control intake and exhaust valves (37 and 43—see FIGS. 2 and 3).

Also shown in FIG. 3 is a Mass Air Flow Sensor (MAF) sensor 54 in the air intake path 56 upstream of the throttle 22. This MAF sensor 54 provides mass air flow signals from the air intake path to the ECU 40. A manifold absolute pressure (MAP) sensor 24 in the intake manifold 32 provides manifold absolute pressure signals to the ECU 40.

The ECU 40 includes a variable valve timing controller 41 to be described in more detail later for providing signals for controlling variable valve timing actuators to varying the timings of the opening and closing of the valves for the combustion chambers formed by the cylinders of the internal combustion engine shown in FIG. 3. An exhaust manifold 46 leads to a catalytic converter 50 and an exhaust system (not shown).

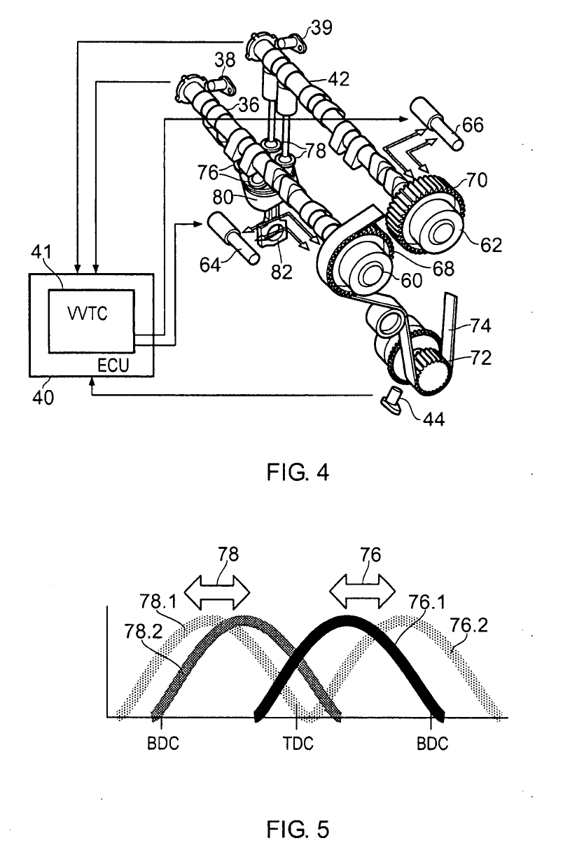

FIG. 4 is a schematic diagram, illustrating in more detail, aspects of an example variable valve timing mechanism. FIG. 4 illustrates that the ECU 40 is operable to receive signals from the crank sensor 44 and from the inlet and exhaust cam sensors 38 and 39. The crank sensor 44 and the inlet and exhaust cam sensors 38 and 39 provide signals indicating the relative rotational positions of the crank shaft (not shown) and the inlet and exhaust cam shafts 36 and 42, respectively. The ECU 40 is operable to provide control signals to variable valve actuators 64 and 66 which are operable, for example hydraulically, to adjust the relative positions of the inlet and exhaust cam shafts 36 and 42, respectively, with respect to the crank shaft through adjusters 60 and 62, respectively. The adjuster 60 interconnects the toothed wheel 68 with the intake camshaft 36 at an adjustable cam shaft angle. The adjuster 62 interconnects the toothed wheel 70 with the exhaust camshaft 42 at an adjustable cam shaft angle. The toothed wheels 68 and 70 are each driven by the cam belt 74 which in turn is driven by the drive wheel 70 connected to the crankshaft of the internal combustion engine. The timing of the opening and closing of the intake valves 76 can therefore be controlled by means of the actuator 64 which acts on the adjuster 60. Similarly, the timing of the opening and closing of the exhaust valves 78 can be controlled by the actuator 66 operating on the adjuster 62. Adjusting the timing of the intake and exhaust valve openings and closings can enable the combustion in the combustion chamber in the head of the cylinder over the piston 80 according to varying engine operating parameters. The big end 82 of the conrod connected to the piston 80 acts on the crank shaft (not shown) to turn the crank shaft and causes the drive wheel 72 at the end of the crankshaft to be turned therewith.

FIG. 5 illustrates a range of valve operating positions for the intake valve 76 and the exhaust valve 78. The intake valve operation can vary between a most advanced position 76.1 and a most retarded position 76.2. The exhaust valve operation can vary between a most advanced position 78.1 and a most retarded position 78.2. The curves shown in FIG. 5 represents the valve lift quantity (i.e., the valve displacement with respect to a closed position) for the intake valves and exhaust valves with respect to a piston top dead centre (TDC) timing and piston bottom dead centre (BDC) timings.

Adjusting the valve timings can improve characteristics such as power, torque, fuel consumption and exhaust emissions according to particular driving patterns. For example, when a specified vehicle driving pattern is traced, fuel consumption can be improved, NOx emissions can be reduced, HC emissions can be reduced and torque can be improved.

For example, under heavy loads, or at low and intermediate speeds, larger torque is typically required, whereby the intake valve timing can be advanced and, in a system where intake and exhaust valve timing is provided, the exhaust valve timing can be retarded. Under heavy loads or at high speeds, larger power is required and in such a situation, the intake valve timing can be retarded. Under intermediate loads, fuel consumption and exhaust gas reduction takes precedence, whereby in a system having only intake variable valve timing, the intake valve timing can be advanced, whereas in a system with intake and exhaust variable valve timing, the intake and exhaust valve timing can both be retarded.

FIGS. 3 and 4 assume an engine system with variable valve timing for the intake and exhaust valves. However, it will be appreciated that in other examples, variable valve timing may be provided for the intake valves only.

As mentioned above, the example variable valve timing system illustrated in FIG. 4 can be a conventional hydraulic variable valve timing system. In other examples, the variable valve timing system could be an electrically operated variable valve timing system. It will be appreciated that the invention is applicable to and engine control system for an engine with any form of any variable valve timing, including engine control systems where valve timing is operated without camshafts.

As technology develops, variable valve timing systems are becoming more responsive in order to improve the efficiency and environmental effectiveness of the internal combustion engines. As a result, the valve timing can change during an engine cycle in which a transient situation occurs. The amount of air induced into a cylinder may change after a fuel amount calculation due to a change in the variable valve timing. In view of this, an embodiment of the present invention seeks to introduce a time delay in a variable valve timing system intentionally in order that engine volumetric efficiency can be predicted and thereby it becomes possible to calculate accurate injection amounts in the case of variable valve timing transients.

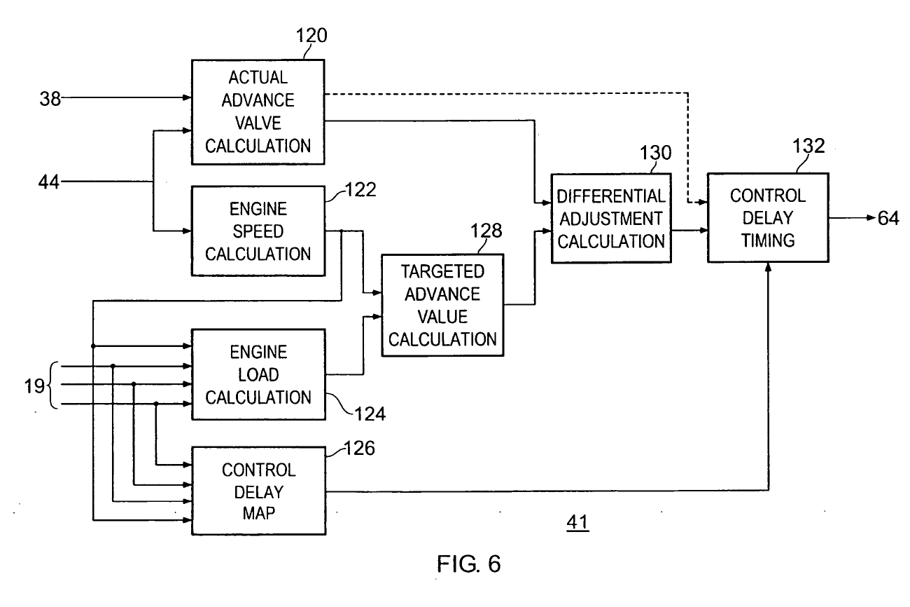

FIG. 6 is a schematic block diagram of functional elements of Variable Valve Timing Controller 41 of the ECU 40 illustrated in FIG. 3. The functional elements of the VVTC 41 illustrated in FIG. 6 are for providing a variable intake valve timing to be controlled using a variable valve timing system as illustrated in FIGS. 3 and 4.

In the example embodiment shown in FIG. 6, actual advance valve calculation logic 120 receives cam angle sensor signals from the intake cam sensor 38 and also crank sensor signals from the crank sensor 44. Engine speed calculation logic 122 also receives signals from the crank sensor 44. Engine load calculation logic 124 receives an engine speed signal from the engine speed calculation logic 122 and various sensor signals 19 including a throttle angle signal, a signal representative of a current intake valve timing, ambient pressure signals, intake temperature signals, etc. An engine load value computed by the engine load calculation logic 124 is provided to targeted advance value calculation logic 128, which also receives an engine speed value from the engine speed calculation logic 122. Differential adjustment calculation logic 130 receives an actual advance value for the intake valves computed by the actual advance valve calculation logic 120 and also a targeted advance value for the intake valves computed by targeted advance value calculation logic 128. The output of the differential adjustment calculation logic 132 is a signal to be supplied to the intake variable valve timing actuator 64 for causing an adjustment of the intake valve timing.

However, in an embodiment of the invention, a control delay timing circuit 132 receives a delay signal output from a control delay map logic 126 which is responsive to various engine operating parameters to determine a control delay according to the operating parameters. As indicated in FIG. 6, the control delay map logic 126 receives the same signals as the engine load calculation logic 124. However, in another embodiment, different sets of signals can be input to the control delay map unit 126, which contains a multi-dimensional map for generating the delay signal to be provided to the control delay timing unit for delaying the passing of the signal output from the differential adjustment calculation logic 132 to the variable valve actuator 64.

The control delay is a delay determined such that the combination of the control delay and a system delay, which forms the time taken after providing a control signal to the intake valve variable valve timing actuator 64 before the actual adjustment of the variable valve timing angle occurs, forms a total delay corresponding to the time between an injection time calculation timing and the closing of the intake valve.

It should be appreciated that FIG. 6 represents one example only of an example engine control module. It will be appreciated that many modifications may be made thereto.

For example, in example embodiment illustrated in FIG. 6, a target variable valve timing computation is based on estimated load. However, it should be understood that this is merely one example and in other example embodiments, target valve timing computation could be based on a target load.

Also, in the example shown in FIG. 6, delay timing control is based on a difference in target verses actual variable valve timing, for example using a PID controller. However, the controller could be implemented in another form, for example by way of a model based controller without direct feedback.

Further, in the example shown in FIG. 6, the delay calculation is based on the same parameters as the target calculation. However, in another example the delay can be calculated as a fixed angle compensation for the actual variable valve timing angle, for example as represented by the dotted line between the actual advance valve calculation logic 120 and the control delay timing logic 132.

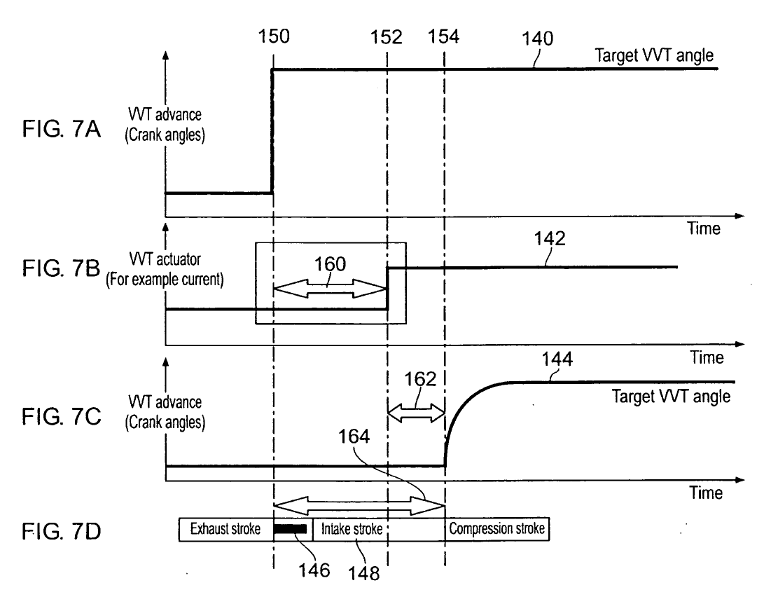

The various delays are indicated in FIG. 7, which includes various timing diagrams.

FIG. 7A is a timing diagram showing a trace 140 of variable valve advance (in terms of crank angles) versus time and showing a target variable valve timing angle to be achieved at a particular point which corresponds to the start 150 of a fuel injection timing period.

FIG. 7B illustrates a trace 142 of a variable valve timing actuator signal (for example, a current value provided to the intake valve variable valve timing actuator 64) and illustrates the control delay 160 between a fuel amount (or injection) calculation timing 150 (which in the example illustrated happens to correspond to a start of the fuel injection timing period, but which could be before or after the start of the fuel injection timing) and a timing 152 when the variable valve timing actuator signal is provided to the variable valve actuator 64.

FIG. 7C also shows the actual variable valve timing advance (in terms of crank angles), showing the additional system delay 162 between the activation of the actuator 64 at 152 by the provision of the control signal and the actual adjustment of the variable valve timing angle that starts to occur at intake valve closing timing 154.

As represented in FIG. 7D, the combination of the control delay 160 and the system delay 162 provides a total delay time 164 that corresponds to the time between the injection calculation timing 150 and the actual adjustment of the variable valve timing angle at 154, at the end of the intake stroke 148.

Accordingly, as shown in FIG. 7, the total delay is chosen to correspond to the time from the injection calculation timing 150 until the end of the intake stroke at 154, whereby the amount of fuel injected can be determined in a way that predicts engine volumetric efficiency. In other words, accurate injection amounts can be calculated in variable valve transient situations to provide effective emission control by adding the intentional control delay prior to variable valve timing actuator activation such that the total variable valve timing delay matches the time between the injection time calculation timing and the closing of the intake valve.

It will be appreciated that logic corresponding to that shown in FIG. 6 can also be provided for exhaust valve timing in an engine system such as shown in FIGS. 3 and 4, where variable valve timing is provided for intake and exhaust valves.

It should also be appreciated that although in the above description, reference is made to a control delay in terms of a timing, it should be appreciated that the control delay can be represented in terms of a delay angle value than a time value for controlling the variable valve timing.

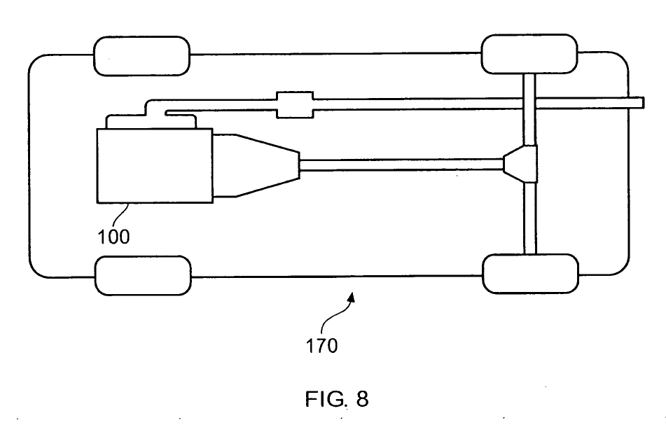

FIG. 8 is a schematic representation of a vehicle including an engine system such as the engine system 100 described hereinabove. As shown in FIG. 8, the vehicle is a rear wheel drive vehicle, although it will be appreciated that the invention could be applied to an engine system in any appropriate type of vehicle. There has been described an engine control system for an internal combustion system having variable valve timing operated by at least one variable valve actuator. The engine control system can calculate fuel injection amounts based on predicted volumetric efficiency and can delay a control signal for initiation of the variable valve actuator by a control delay timing in transient variable valve actuation situations.

Although the embodiments above have been described in considerable detail, numerous variations and modifications will become apparent to those skilled in the art once the above disclosure is fully appreciated. It is intended that the following claims be interpreted to embrace all such variations and modifications as well as their equivalents.

What is claimed is:

1. An engine control system for an internal combustion system having variable valve timing operated by at least one variable valve actuator, the engine control system being operable to calculate fuel injections amounts based on predicted volumetric efficiency, the engine control system being operable to delay a control signal for initiation of the variable valve actuator by a control delay timing.

2. The engine control system of claim 1, wherein a total variable valve actuation delay timing comprises the control delay timing and a system delay timing, the system delay timing being an activation timing for activating the variable valve actuator in response to the control signal.

3. The engine control system of claim 2 wherein the control delay timing is determined such that the total delay timing corresponds to a time between an injection time calculation during which fuel is injected for an engine combustion chamber and the closing of an intake valve of the combustion chamber.

4. The engine control system of claim 3, wherein the control delay timing is a fixed constant.

5. The engine control system of claim 3, wherein the control delay timing is variable dependent upon at least one input parameter.

6. The engine control system of claim 5, wherein the control delay timing is determined from a mapping responsive to the at least one parameter.

7. An internal combustion engine having variable valve timing operated by at least one variable valve actuator, the internal combustion engine comprising an engine control system operable to calculate fuel injections amounts based on predicted volumetric efficiency, the engine control system being further operable to delay a control signal for initiation of the variable valve actuator by a control delay timing.

8. The engine control system of claim 7, wherein internal combustion engine is a port fuel injection engine.

9. The engine control system of claim 7, wherein internal combustion engine is a direct fuel injection engine.

10. A method of controlling variable valve timing of an internal combustion system, the variable valve timing being operated by at least one variable valve actuator, the method comprising calculating fuel injections amounts based on predicted volumetric efficiency, and delaying a control signal for initiation of the variable valve actuator by a control delay timing.

11. The method of claim 10, wherein a total variable valve actuation delay timing comprises the control delay timing and a system delay timing, the system delay timing being an activation timing for activating the variable valve actuator in response to the control signal.

12. The method of claim 11, wherein the control delay timing is such that the total delay timing corresponds to a time between an injection time calculation during which fuel is injected for an engine combustion chamber and the closing of an intake valve of the combustion chamber.

13. The method of claim 12, wherein the control delay timing is fixed constant.

14. The method of claim 12, wherein the control delay timing is variable dependent upon at least one input parameter.

15. The method of claim 14, wherein the control delay timing is determined from a mapping responsive to the at least one parameter.
